(19) United States
(12) Patent Application Publication
(10) Pub. No.: US 2023/0138662 A1
(43) Pub. Date: May 4, 2023

(54) COMPOSITION AND METHOD FOR STIMULATING PLANT GROWTH AND PRODUCTIVITY

(71) Applicants: Andrew Butler, Markham (CA); Bryan Quoc Le, Sequim, WA (US)

(72) Inventors: Andrew Butler, Markham (CA); Bryan Quoc Le, Sequim, WA (US)

(21) Appl. No.: 17/513,384

(22) Filed: Oct. 28, 2021

(51) Int. Cl. C05B 17/00

(52) U.S. Cl. CPC C05B 17/00

(57) ABSTRACT

An improved composition and method for stimulating plant growth and productivity, the composition of which can be adjusted to provide a preferred pH level that is ideal for growing plants in order to enhance the uptake of certain nutrients in growing such plants. The composition comprises combinations of Citric Acid, Disodium Hydrogen Phosphate or one of its hydtares, Boric Acid and Trisodium Phosphate or Trisodium Phosphate Dodecahydrate dissolved with a set quantity of water.

### FIELD OF THE INVENTION

The present invention relates to an improved composition and method for stimulating plant growth and productivity, the composition of which can be adjusted to provide a preferred pH level (for example, between 4.0 to 8.0 pH) that is ideal for growing plants, and particularly medically grown cannabis, in order to enhance the uptake of certain nutrients in growing such plants.

### DESCRIPTION OF THE PRIOR ART

It is known that, when watering plants, water can be mixed with various compositions to supply nutrients that use beneficial microbes to assist with root development and increase water and nutrient absorption, amongst other things, as well as yield.

Furthermore, when growing plants, typically such plants uptake nutrients best within a certain pH range. A pH level of between 5.8-6.2, for example, is ideal for growing plants, and particularly medically grown cannabis, in order to uptake certain nutrients such as nitrogen phosphorus, potassium, calcium, sulphur, magnesium, iron, manganese, boron, copper, zinc, and molybdenum. However, most conventional compositions for this purpose have a pre-defined and set pH level associated with them, and the pH level cannot be varied. Depending upon the plant being grown, it would be ideal to have a composition which can be adjusted and dissolved to provide a preferred pH level, for example, to be between 4.0 to 8.0 pH.

Accordingly, there is a need for an improved composition and method for stimulating plant growth and productivity. There is a further need for an improved composition and method for stimulating plant growth and productivity (particularly medically grown cannabis) the composition of which can be adjusted to meet the requirements of a wide range of plants (4.0 to 8.0 pH), in order to enhance the uptake of certain nutrients such as nitrogen phosphorus, potassium, calcium, sulphur, magnesium, iron, manganese, boron, copper, zinc, and molybdenum for these plants.

To this end, the present invention effectively addresses these needs.

### SUMMARY OF THE INVENTION

A general object and advantage of the present invention is to provide an improved composition and method for stimulating plant growth and productivity.

A still further object and advantage of the present invention is to provide an improved composition and method for stimulating plant growth and productivity, the composition of which can be adjusted to provide a preferred pH level (for example, between 4.0 to 8.0 pH) that is ideal for growing plants, and particularly medically grown cannabis, in order to enhance the uptake of certain nutrients in growing such plants.

According to one aspect of the present invention, there is provided a composition for stimulating plant growth and productivity, comprising a set quantity of water; a pre-set amount of Citric Acid or Citric Acid Monohydrate for dissolving in the set quantity of water; and a pre-set amount of anhydrous Disodium Hydrogen Phosphate or one of its hydrates being selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water.

According to another aspect of the present invention, there is provided a composition for stimulating plant growth and productivity, comprising a set quantity of water; a pre-set amount of Citric Acid or Citric Acid Monohydrate for dissolving in the set quantity of water; and a pre-set amount of Boric Acid for dissolving in the set quantity of water; and a pre-set amount of anhydrous Trisodium Phosphate or Trisodium Phosphate Dodecahydrate for dissolving in the set quantity of water.

According to another aspect of the present invention, there is provided a method for creating a composition for stimulating plant growth and productivity, comprising the steps of providing a set quantity of water; delivering a pre-set amount of Citric Acid or Citric Acid Monohydrate for dissolving in the set quantity of water; and delivering a pre-set amount of anhydrous Disodium Hydrogen Phosphate or one of its hydrates selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water.

According to another aspect of the present invention, there is provided a method for creating a composition for stimulating plant growth and productivity, comprising the steps of providing a set quantity of water; delivering a pre-set amount of Citric Acid or Citric Acid Monohydrate for dissolving in the water, the Citric Acid or the Citric Acid Monohydrate being in a range of between 0.21 grams to 5.89 grams for every 100 ml of the water; and delivering a pre-set amount of anhydrous Disodium Hydrogen Phosphate or one of its hydrates selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water, the anhydrous Disodium Hydrogen Phosphate or the one of its hydrates being in a range of between 5.47 grams to 11.15 grams for every 100 ml of the water.

According to another aspect of the present invention, there is provided a method for creating a composition for stimulating plant growth and productivity, comprising the steps of providing a set quantity of water; delivering a pre-set amount of Citric Acid or the Citric Acid Monohydrate for dissolving in the water, the Citric Acid or the Citric Acid Monohydrate being in a range of between 4.94 grams to 8.16 grams for every 100 ml of the water; delivering a pre-set amount of Boric Acid for dissolving in the set quantity of water, the Boric Acid being in a range of between 6.36 grams to 10.51 grams for every 100 ml of the water; and delivering a pre-set amount of anhydrous Trisodium Phosphate or Trisodium Phosphate Dodecahydrate for dissolving in the set quantity of water, the Trisodium Phosphate or the Trisodium Phosphate Dodecahydrate being in a range of between 4.05 grams to 11.41 grams for every 100 ml of the water.

According to another aspect of the present invention, there is provided a composition for stimulating plant growth and productivity, comprising a set quantity of water; a pre-set amount of Citric Acid or the Citric Acid Monohydrate for dissolving in the set quantity of water; and a pre-set amount of anhydrous Disodium Hydrogen Phosphate or one of its hydrates selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water.

### DESCRIPTION OF THE PREFERRED EMBODIMENT

The present invention relates to an improved composition and method for stimulating plant growth and productivity, the composition of which can be adjusted to meet the requirements of a wide range of plants (4.0 to 8.0 pH), in order to enhance the uptake of certain nutrients for these plants such as, but not limited to, nitrogen phosphorus, potassium, calcium, sulphur, magnesium, iron, manganese, boron, copper, zinc, and molybdenum.

In an exemplary embodiment, the composition and method of the present invention is used to create a composition for watering plants in a concentrated formula. The chemical components of this composition are detailed as dissolved into 100 ml of water, but the amount of chemicals and water can be increased to provide a desired batch amount, in terms of scalability, as would be understood by one skilled in the art.

In one embodiment, the composition comprises quantities of Citric Acid or its hydrate and Disodium Hydrogen Phosphate (Na₂HPO₄) or one of its hydrates dissolved into 100 ml of water.

In Table 1 set forth below it can be seen that to achieve a desired 4.0 pH level for the composition, 5.89 grams of Citric Acid Monohydrate and 5.47 grams of Disodium Hydrogen Phosphate are dissolved into 100 ml of water to create the composition.

TABLE 1

| COMPONENT | Citric Acid Monohydrate (g) | Disodium Hydrogen Phosphate(g) | Water |
|---|---|---|---|
| pH level desired | | | |
| 4 | 5.89 | 5.47 | 100 mL |
| 4.5 | 5.09 | 6.27 | 100 mL |
| 5 | 4.42 | 6.94 | 100 mL |
| 5.5 | 3.85 | 7.50 | 100 mL |
| 6 | 3.22 | 8.14 | 100 mL |
| 6.5 | 2.46 | 8.90 | 100 mL |
| 7 | 1.44 | 9.92 | 100 mL |
| 7.5 | 0.59 | 10.77 | 100 mL |
| 8.0 | 0.21 | 11.15 | 100 mL |

As can be seen the amount of chemicals used can be varied to adjust the pH level of the composition, to meet the requirements of a wide range of plants, preferably from 4.0 to 8.0 pH, but can be varied slightly or adjusted to account of the additional mass of the water molecules in the hydrate forms of the salts, as would be understood by one skilled in the art.

One of the advantages of the present invention is that the pH level of the composition can be adjusted since, when growing plants, certain plants uptake nutrients best within a defined pH range in order to uptake certain nutrients such as (but not limited to) nitrogen phosphorus, potassium, calcium, sulphur, magnesium, iron, manganese, boron, copper, zinc, and molybdenum. For example, a pH level of 5.8-6.2 is ideal for growing medically grown cannabis, a pH level of 5.5 for apple trees could be obtained, peach trees at a pH level of 6.5, bonsai at a 7.0 pH level, as other minor examples.

In a further embodiment, the composition comprises quantities of Citric Acid or its hydrate, Boric Acid and Trisodium Phosphate (Na₃PO₄) or its hydrate dissolved into 100 ml of water. In Table 2 set forth below it can be seen that to achieve a desired 4.0 pH level for the composition, 8.16 grams of Citric Acid, 10.51 grams of Boric Acid and 4.05 grams of Trisodium Phosphate are dissolved in 100 ml of water to create the composition. Again, the amount of chemicals and water can be increased to provide a desired batch amount, in terms of scalability, or adjusted to account for the increased mass of the hydrates as would be understood by one skilled in the art.

TABLE 2

| COMPONENT | Citric Acid (g) | Trisodium Phosphate(g) | Water | Boric Acid (g) |
|---|---|---|---|---|
| pH level desired | | | | |
| 4 | 8.16 | 4.05 | 100 mL | 10.51 |
| 4.5 | 7.70 | 5.11 | 100 mL | 9.91 |
| 5 | 7.26 | 6.11 | 100 mL | 9.35 |
| 5.5 | 6.91 | 6.92 | 100 mL | 8.89 |
| 6 | 6.54 | 7.76 | 100 mL | 8.42 |
| 6.5 | 6.12 | 8.72 | 100 mL | 7.88 |
| 7 | 5.64 | 9.82 | 100 mL | 7.26 |
| 7.5 | 5.30 | 10.61 | 100 mL | 6.82 |
| 8.0 | 4.94 | 11.41 | 100 mL | 6.36 |

As noted previously, the amount of chemicals used can be varied to adjust the pH level of the composition, to meet the requirements of a wide range of plants, preferably from 4.0 to 8.0 pH, and the amounts noted above are not absolutes, but can be varied slightly, as would be understood by one skilled in the art.

In a still further embodiment of the present invention, the composition embodiments noted above can also be utilized in conjunction with a foliar spray, which would be sprayed on the leaves of the plant at desired intervals. Such a foliar spray could also be used to fight, for example, mold/mildew on the plants, and well as increasing Tetrahydrocannabinol (THC) when growing medically grown cannabis, for example. Such a configuration of a foliar spray could comprise (in 1 gallon of water) 31.2 grams of Potassium Bicarbonate; 2.6 mL of Liquid soap (castile soap); 0.628 grams of Salicylic acid or 0.468 grams of gamma aminobutyric acid (GABA); 20-40 grams of Powdered giant knotweed (Reynoutria sachalinensis); and 0.05% (1.9 mL to 1 gallon) to 1% (38 mL to 1 gallon) of Dimethylsulfoxide (DMSO). Again, the amount of chemicals and water can be increased to provide a desired batch amount, in terms of scalability, as would be understood by one skilled in the art. Further, to decrease costs, one skilled in the art could appreciate that the knotweed (Reynoutria sachalinensis) and the Dimethylsulfoxide (DMSO) could be omitted, if desired, and instead focus on the salicylic acid or gamma aminobutyric acid (GABA) as additives.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A composition for stimulating plant growth and productivity, comprising:
a set quantity of water;
a pre-set amount of Citric Acid or Citric Acid Monohydrate for dissolving in the set quantity of water; and
a pre-set amount of anhydrous Disodium Hydrogen Phosphate or one of its hydrates being selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water.

2. The composition of claim 1, wherein the pre-set amount of the Citric Acid or the Citric Acid Monohydrate and the pre-set amount of the anhydrous Disodium Hydrogen Phosphate or the one of its hydrates are adjusted to define a desired pH level of the composition at a pre-set level.

3. The composition of claim 2, wherein the pre-set level of the pH level in the composition is adjusted to be between 4.0 and 8.0.

4. The composition of claim 1, wherein the pre-set amount of the Citric Acid or the Citric Acid Monohydrate dissolved is in a range of between 0.21 grams to 5.89 grams for every 100 ml of the water.

5. The composition of claim 1, wherein the pre-set amount of the anhydrous Disodium Hydrogen Phosphate or the one of its hydrates dissolved is in a range of between 5.47 grams to 11.15 grams for every 100 ml of the water.

6. A composition for stimulating plant growth and productivity, comprising:
a set quantity of water;
a pre-set amount of Citric Acid or Citric Acid Monohydrate for dissolving in the set quantity of water; and
a pre-set amount of Boric Acid for dissolving in the set quantity of water; and
a pre-set amount of anhydrous Trisodium Phosphate or Trisodium Phosphate Dodecahydrate for dissolving in the set quantity of water.
The composition of claim 6, wherein the pre-set amount of the Citric Acid or the Citric Acid Monohydrate, the pre-set amount of the Boric Acid and the pre-set amount of the anhydrous Trisodium Phosphate or the Trisodium Phosphate Dodecahydrate are adjusted to define a desired pH level of the composition at a pre-set level .

7. The composition of claim 6, wherein the pre-set level of the pH level in the composition is adjusted to be between 4.0 and 8.0.

8. The composition of claim 6, wherein the pre-set amount of the Citric Acid or the Citric Acid Monohydrate dissolved is in a range of between 4.94 grams to 8.16 grams for every 100 ml of the water.

9. The composition of claim 6, wherein the pre-set amount of the Boric Acid dissolved is in a range of between 6.3 grams to 10.51 grams for every 100 ml of the water.

10. The composition of claim 6, wherein the pre-set amount of the anhydrous Trisodium Phosphate or the Trisodium Phosphate Dodecahydrate dissolved is in a range of between 4.05 grams to 11.41 grams for every 100 ml of the water.

11. A method for creating a composition for stimulating plant growth and productivity, comprising the steps of:
providing a set quantity of water;
delivering a pre-set amount of Citric Acid or Citric Acid Monohydrate for dissolving in the set quantity of water; and
delivering a pre-set amount of anhydrous Disodium Hydrogen Phosphate or one of its hydrates selected from the group consisting of Disodium Hydrogen Phosphate Dihydrate, Disodium Hydrogen, Phosphate Heptahydrate, Disodium Hydrogen Phosphate Octahydrate, Disodium Hydrogen and Phosphate Dodecahydrate for dissolving in the set quantity of water.

12. The method of claim 11, further comprising the step of adjusting the pre-set amount of the Citric Acid or the Citric Acid Monohydrate and the pre-set amount of the anhydrous Disodium Hydrogen Phosphate or the one of its hydrates to define a desired pH level of the composition at a pre-set level.

13. The method of claim 12, wherein the pre-set level of the pH level in the composition is adjusted to be between 4.0 and 8.0.

14. The method of claim 11, further comprising the step of dissolving the Citric Acid or the Citric Acid Monohydrate in the set quantity of water in a range of between 0.21 grams to 5.89 grams for every 100 ml of the water.

15. The method of claim 11, further comprising the step of dissolving the anhydrous Disodium Hydrogen Phosphate or the one of its hydrates in the set quantity of water in a range of between 5.47 grams to 11.15 grams for every 100 ml of the water.
